(19) United States
(12) Patent Application Publication
(10) Pub. No.: US 2022/0204246 A1
(43) Pub. Date: Jun. 30, 2022

(54) METHOD AND CONTAINER FOR SHIPPING A FROZEN FOOD PRODUCT

(71) Applicant: Torrey WOODCOCK, Sullivan, MO (US)

(72) Inventor: Torrey WOODCOCK, Sullivan, MO (US)

(21) Appl. No.: 17/137,101

(22) Filed: Dec. 29, 2020

(51) Int. Cl. B65D 81/38; F25D 3/08

(52) U.S. Cl. CPC B65D 81/3862; F25D 2331/804; F25D 3/08

(57) ABSTRACT

This disclosure relates to a method and container for shipping a frozen food product, normally in the form of an uncooked fruit pie, with a decorative container for holding the food product such that the decorative container is adjacent to the frozen food product which in turn is positioned adjacent to a refrigeration component to maintain the frozen product frozen during shipment. The combination provides an unusual gifting opportunity providing a reusable laser engraved commemorative and reusable memorabilia for celebrating life's important events. Preferably the food product is uncooked and is conventionally baked by the recipient or by another prior to presentation to the intended recipient.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND

In our fast-paced world, finding a thoughtful gift commemorating life's events can be more difficult than expected. My invention combines the ability to provide a thoughtful gift, for example, to recipients having essentially a two-part function. First, there is the ability to provide a desirable consumable product which, as a second attribute, provides a decorative component suitable for retention as a keepsake. To accomplish these functions, I designed a shipping container for the product enabling an uncooked edible portion to be shipped in interstate commerce while maintaining a consistently high product quality in the edible gift portion.

The prior art reveals a long list of patents dealing with shipping food products and/or delivering food product for later consumption by the recipient. There are several pizza boxes designs, potpie combinations and even frozen fruit pie products available to the consuming public. The packaging industry for a long time was overly concerned with packaging products compatible with both microwave heating and microwave cooking of the consumables. Merely by way of example and not of limitation, U.S. Pat. No. 2,068,540 issued Jan. 19, 1937 is an early example of a container for pies, cakes and similar products for handling and shipment along with a display package where hopefully sales are enhanced. Likewise, U.S. Pat. No. 6,733,808 B2 is directed to a 1 dish frozen dinner product. Despite the available large body of prior art, no one has previously determined that providing the food product in a commemorative combination with the food product container could spawn a successful commercial business. While these prior art attempts work well for their intended purposes, to applicant's knowledge none addressed the specific purpose or problems associated with delivering consistently high quality food products to the consuming public in conjunction with incorporating a two part packaging design which made a portion of the package suitable for retention by the recipient.

### BRIEF SUMMARY

In accordance with this disclosure generally stated, a gift package is provided having an edible component and a keepsake component. The edible component preferably is in the form of an uncooked food product which is shipped with the keepsake component for delivery. The package preferably includes an outer closure defining an internal volume sized to receive a plurality of inserts. The first insert defines an internal volume designed to receive a cold pack chosen to maintain the frozen product in its frozen condition during shipment. A second insert defines an internal volume sized to receive the consumable component of the gift package along with certain components for preparing the consumable component. The third insert comprises the keepsake portion of the package and preferably includes a top wall engraved with a commemoration message intended for the eventual recipient and comprises the keepsake component of the gift. The number of inserts and relative position of each may vary in various embodiments of the disclosure and various combinations of insulation material may be included, if desired.

### BRIEF DESCRIPTION OF THE DRAWINGS

FIG. 1 is a view in prospective of an outer enclosure showing use of an insulation layer used in conjunction with a flexible package defining the first insert;

FIG. 1a is a view in prospective of enclosure of FIG. 1 showing the enclosure of FIG. 1 conventionally has 6 sides defining a predetermined volume along a horizontal axis of the enclosure;

FIG. 2 is a view in prospective of the third insert container defining internal volume positioned within the enclosure shown in FIG. 1;

FIG. 3 is a top plan of the second insert container defining an internal volume for holding the food product of the present disclosure;

FIG. 4 is a top plan showing the insert of FIG. 3 in an open condition illustrating the inclusion of a no mess ring and instruction sheet included within the insert shown in FIG. 3;

FIG. 5 is a view in prospective showing baking instructions and a no mess ring used in conjunction with the edible component of the present disclosure;

FIG. 6 is a view to prospective showing the edible component of the present disclosure positioned within its associated no mess ring;

FIG. 7 is a plan view of the baking instructions for the present disclosure; and

FIG. 8 is a plan view showing illustrative examples of possible various top walls used to create the enclosure for the insert shown in FIG. 2.

Corresponding reference numerals are used for similar components throughout the several figures of the drawings.

### DETAILED DESCRIPTION

The following detailed description illustrates the claimed invention illustratively described in this disclosure by way of example and not by way of limitation. This description will clearly enable one skilled in the art to make and use the claimed invention, and describes several embodiments, adaptations, variations, alternatives and uses of the claimed invention, including what I presently believe is the best mode of carrying out the claimed invention. Additionally, it is to be understood that the claimed invention is not limited in its application to the details of construction and the arrangements of components set forth in the following description or illustrated in the drawings. The claimed intervention of the present disclosure is capable of other embodiments and of being practiced or being carried out in various ways. Also, it is to be understood that the phraseology and terminology used herein is for the purpose of description and should not be regarded as limiting.

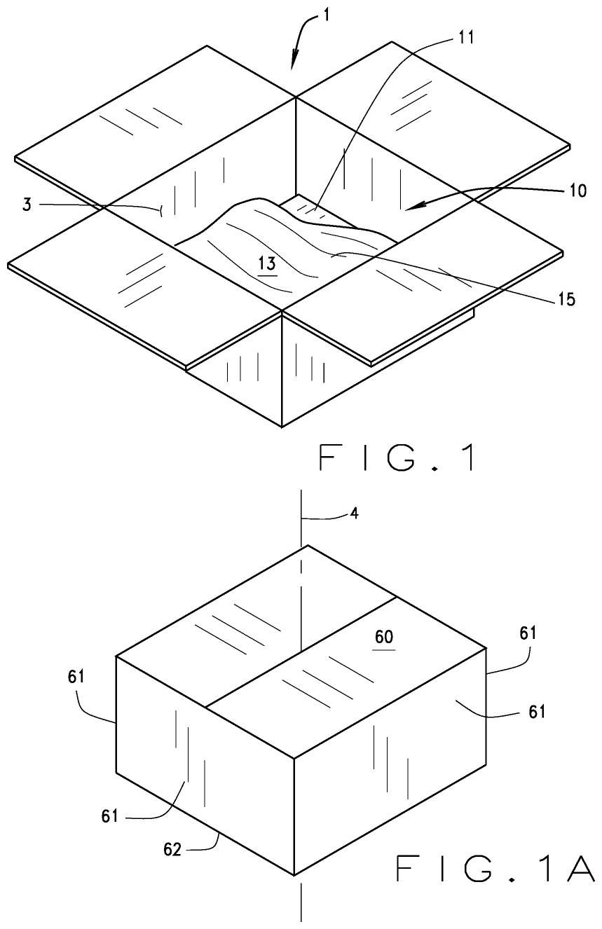

Referring now to FIG. 1 a reference numeral 1 indicates a six-sided container defining an enclosed volume 3 along an axis 4. The container 1 is conventional and may comprise any suitable construction for the purpose of the present disclosure. In the embodiment illustrated, the container 1 is a conventional cardboard construction shipping box conventionally including a top 60, 4 sidewalls 61 and a bottom wall 62. Other construction forms compatible with the broader scope of the present disclosure.

In the embodiment illustrated, a first insert 10 includes an insulator 11 typically constructed from Styrofoam. The insulator 11 supports a flexible package 13. The package 13's size to contain a sufficient amount of dry ice 15 calculated to maintain a food product later described in greater detail in a frozen state. Depending upon the shipping distance, the package 13 shown in the drawings is size to receive up to 10 pounds of dry ice. The configuration and contents of the insert 10 are a matter of design choice various changes to which are contemplated in other embodiments of the disclosure.

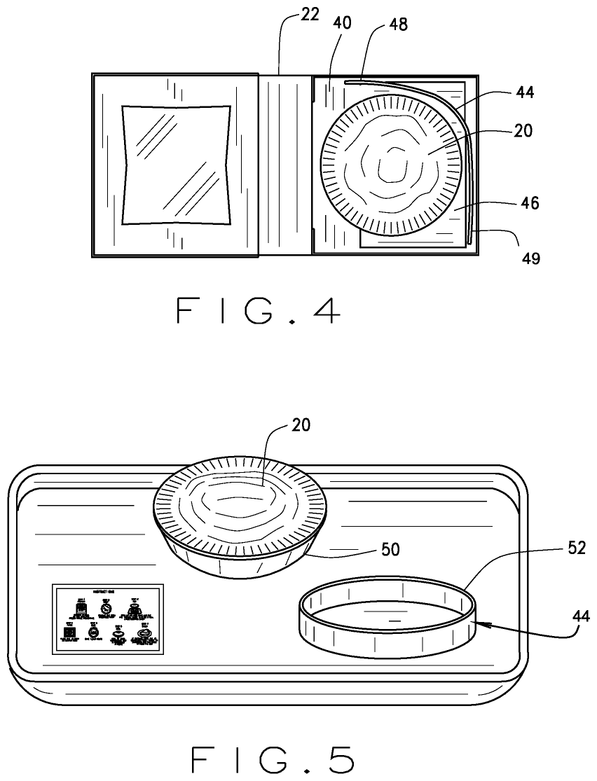

Referring now to FIG. 3, a food product 20 is position within a second insert 22. The second insert 22, in the embodiment illustrated, again is a six-sided cardboard container having a top wall 24. The top wall 24 preferably has a viewing area 26 to expose least a portion of the food product 20 to visual inspection. As indicated above, the food product 20 preferably is an uncooked fruit pie. As will be appreciated by those skilled in the art, other food products, for example, are compatible with the disclosure concepts described herein. The second insert 22 contains additional components included within the container 1 which are described in greater detail with respect to FIGS. 4, 5 and 6.

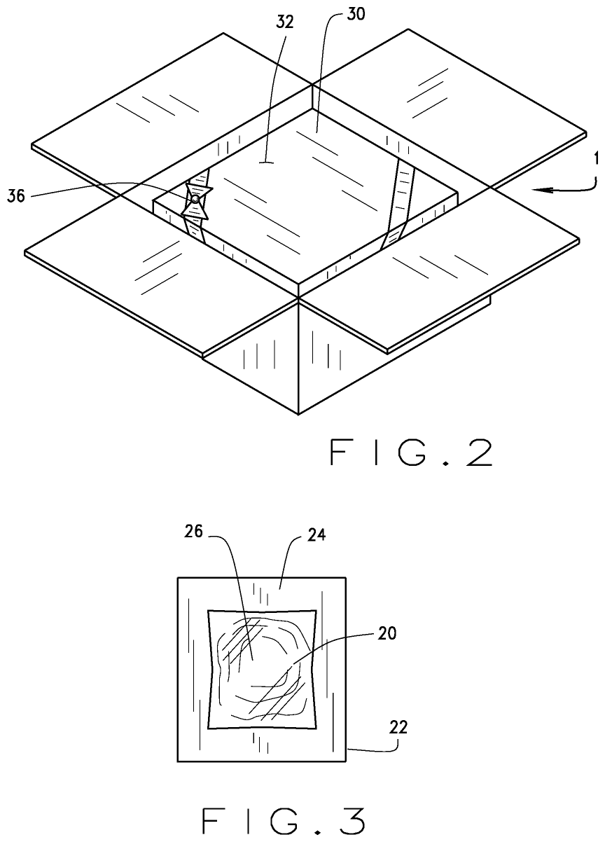

Referring now to FIG. 2, a third insert 30 completes the axial arrangement of the inserts along the axis 4 for the container 1. The insert 30 preferably is intended to be reusable and defines the commemorative memento or keepsake item included within the container 1. In the embodiment illustrated, the insert 30 also is a six-sided structure having a top wall 32 defining a presentation area 34. Preferably, the insert 30 is constructed from wood or other material which is sufficiently attractive to serve as a desirable keepsake item. Other materials are compatible with the broader purpose of the present disclosure.

When ordering a gift shipment of the container 1, a customer may choose from a variety of pre-programed wording for the presentation area 34 and/or provide their own additional artwork for that purpose. As will be appreciated by those skilled in the art, additional decorations to enhance the appearance of the insert 30 also can be made. For example, the embodiment shown in FIG. 2 uses a ribbon and bow combination 36 for that purpose. The use of a ribbon, for example, is merely illustrative of other decorations employable with the insert 30.

Because the food product 20 contained in the second insert 22 is uncooked, prior to making a presentation of the gift, some additional preparation often is required. To facilitate that preparation, the container 1 provides a number of additional components to help complete the final presentation. For example, FIG. 4 shows the food product 20 protected by a removable cover sheet 40. The cover sheet 40 is conventional and may be constructed from any of a variety of removable preferably flexible covers. Also included within the second insert 22 are a no mess ring 44 and an instruction sheet 46.

The no mess ring 44 is an important feature of the present disclosure. As will be appreciated by those skilled in the art, cooking or baking a food product, and particularly an uncooked fruit pie often causes a baking over run resulting an external “mess” which could or can alter the appearance of the food product and more importantly, damage the third insert when the food product is placed in that insert for gift presentation. In order to alleviate that problem to the extent possible I have included the ring 44 in the packaging within container 1

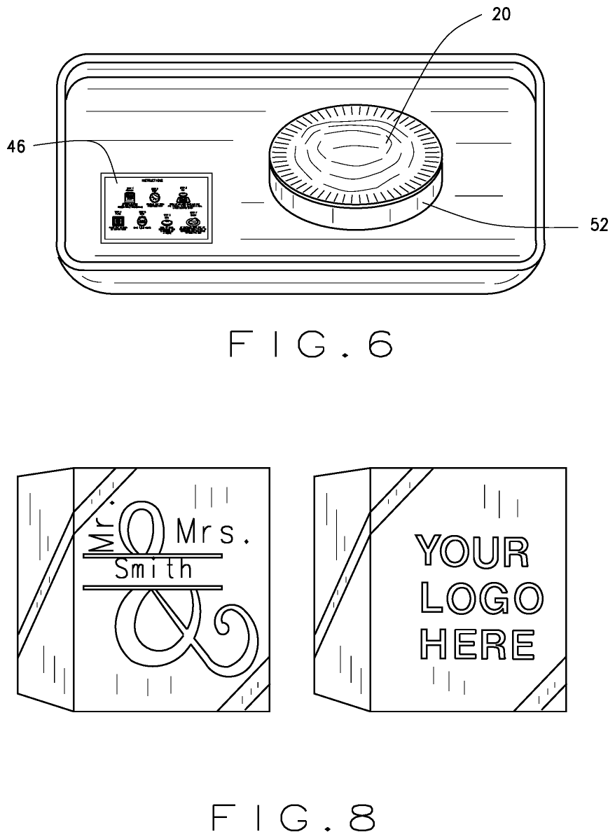

Preferably, the ring 44 has a first arm 48 and a second arm 49. Each of the arms 48 and 49 are designed to interlock with one another to form a part of a continuous loop 52 which is size to receive a pie tin 50 holding the food product in a releasable fit and keeps the pie tin free from overrun even if that should happen with the food product. Proper placement of the food product within the no mess ring 44 is illustratively shown in FIG. 6. The combination of the ring 44 and pie tin 50 ensures that the food product, after cooking, can be placed back into the second insert which in turn is placed within the third insert for presentation to the eventual recipient.

The ring 44 may be constructed from any suitable material that will withstand the temperatures required for cooking the food product 20. As shown in FIG. 7 instructions for completing the presentation the food product 20 is shown. The steps include:

1. Preheating and oven to 375°. Keep the food product 20 frozen while preheating;

2. Remove the freshness wrap or sheet 40 from the food product; 20;

3. Foil line a conventional baking sheet. Open the no mess ring 44 and placed the food product 20 inside. Place the combination on the baking sheet;

4. Place the pie and baking sheet on the center rack of the preheated oven. Bake for 1.5-2 hours;

5. Cool at room temperature for a minimum of 4 hours; and

6. Please food product 20 in the second insert 22 and place the combination in the third insert 34 for presentation.

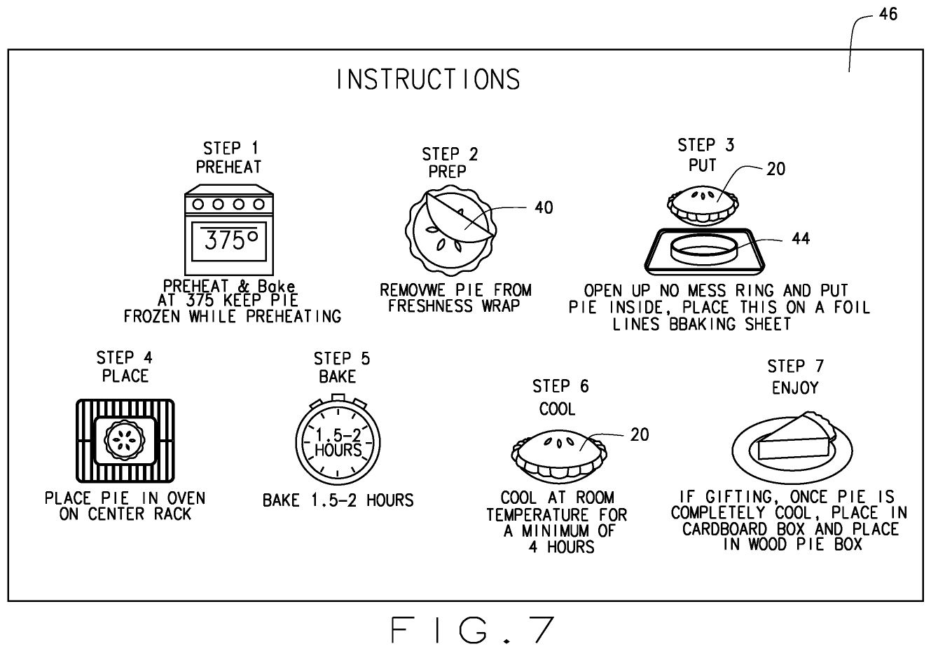

As indicated above, the insert 30, and particularly the top wall 32, can be inscribed with a number of preselected messages. Two of the possible designs are shown in FIG. 8. Any of a number of designs may be used provided they may be inscribed by conventional laser printer not shown.

As will be appreciated by those skilled in the art, the various inserts are sized and position within the enclosure 1 to help minimize damage during shipment of the food product 20. Additional packing and/or insulation material may be included if desired. I have found that the fact that the various inserts disclosed above fit relatively compactly in and fill the volume 3 of the enclosure 1 help to minimize possible damage to the food product 20 during shipment.

As various changes could be made in the above constructions without departing from the scope of the invention, it is intended that all matter contained in the above description or shown in the accompanying drawings shall be interpreted as illustrative and not in a limiting sense. For example, other configurations for the container 1 may be employed in other embodiments in order to accommodate additional food products. Materials employed in the disclosure are what I contemplate is the best mode for the disclosure. Those skilled in the art may vary component size, shape or food product if desired.

1. A container designed to enable shipment of a frozen food product to an intended recipient, comprising:
an outer enclosure having a vertical axis including four sidewalls, a top wall and a bottom wall, the vertical axis having a predetermined height enabling the enclosure to receive a plurality of inserts;
a first insert container sized for insertion in the outer enclosure along the vertical axis of that enclosure, the first insert defining an internal volume designed to receive a cold pack product chosen to maintain the frozen food product in its frozen condition until received by the recipient;
a second insert container size for insertion in the outer enclosure along the vertical axis of that enclosure, the second insert defining the internal volume designed to receive the frozen food product and positioned with respect to the first insert to maintain the frozen food product in its frozen condition until received by the intended recipient; and
a third insert container size for insertion in the second insert container for holding the frozen food product.

2. The container of claim 1 wherein the frozen food product is an uncooked fruit pie.

3. The container of claim 2 wherein the second insert container is a box having at least a partially transparent top wall permitting observation of the uncooked fruit by the recipient.

4. The container of claim 1 wherein the third insert includes a top wall engraved with a commemorative message intended for the recipient.

5. The container of claim 4 wherein the third insert is a wood box defining a volume which is removably open and closed by the engraved top wall.

6. The container of claim 5 wherein the third insert is reusable by the recipient as a commemorative keepsake.

7. The container of claim 1 wherein the cold pack product held by the first insert includes a dry ice portion sized to maintain the frozen food product in the second insert in a frozen condition prior to receipt by a recipient.

8. The container of claim 1 wherein the outer enclosure is a corrugated shipping box.

9. A gift package having an edible component and a keepsake component comprising:
an outer enclosure having a vertical axis including four sidewalls, a top wall and a bottom wall, the vertical axis having a predetermined height enabling the enclosure to receive a plurality of inserts;
a first insert container sized for insertion in the outer enclosure along the vertical axis of that enclosure, the first insert defining an internal volume designed to receive a cold pack product chosen to maintain the frozen food product in its frozen condition until received by the recipient;
a second insert container size for insertion in the outer enclosure along the vertical axis of that enclosure, the second insert defining an internal volume designed to receive the edible component of the gift package in the form of a frozen food product and position with respect to the first insert to maintain the frozen food product in its frozen condition until received by the intended recipient; and
a third insert including a top wall engraved with a commemorative message intended for the recipient comprising the keepsake component of the gift package.

10. The gift package of claim 9 wherein the edible component is a frozen fruit pie held by a pie tin.

11. The gift package of claim 10 wherein the second insert contains a ring size to receive the pie tin of the frozen fruit pie.

12. The gift package of claim 11 wherein the outer enclosure is a cardboard shipping box having a vertical axis size to accept at least three inserts.

13. A method for providing a gift package having an edible component and a keepsake component comprising the steps:
providing an outer enclosure having a predetermined vertical height and a preselected volume;
placing a first insert container containing a cold pack product;
placing a second insert container adjacent the cold pack product, the second container sized to receive the frozen food product;
placing a third insert container adjacent the second insert container, the third container defining a keepsake portion for the gift package;
shipping the gift package;
removing the third and second insert;
preheating an oven to 375° Keep the food product frozen while preheating;
removing a freshness wrap from the food product;
opening a no mess ring and placing the food product inside;
placing the combination ring and food product on the baking sheet;
placing the pie and baking sheet on the center rack of the preheated oven;
baking for 1.5-2 hours;
cooling at room temperature for a minimum of 4 hours;
placing the food product in the second insert; and
placing the combination in the third insert for presentation.

14. The method of claim 13 wherein the no mess ring has corresponding interlocking ends which form an oval shape when interconnected.
